(19) United States
(12) Patent Application Publication
(10) Pub. No.: US 2005/0011379 A1
(43) Pub. Date: Jan. 20, 2005

(54) Stencil master

(75) Inventor: Derek Smith, Clackmannanshire (GB)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: GR Advanced Materials Ltd

(21) Appl. No.: 10/892,936

(22) Filed: Jul. 16, 2004

(30) Foreign Application Priority Data
Jul. 18, 2003 (GB) 0316913.3

(51) Int. Cl. B05C 17/06

(52) U.S. Cl. 101/128.21

(57) ABSTRACT

The present invention is a heat-sensitive stencil master comprising a thermally-activatable colouring agent, and a stencil formed by thermally imaging the stencil master to produce voids and corresponding colour in said thermally-activatable colouring agent.

### FIELD OF THE INVENTION

The present invention relates to digital stencil masters, stencils, methods of making the same, and the use of such stencils, for example in electrochemical etching processes.

### BACKGROUND TO THE INVENTION

Stencil masters comprising an impervious polymeric film and a porous layer are known precursors for the manufacture of stencils for use in digital duplicating processes. In this application, an array of point sources of heat is applied to the stencil master to melt parts of the polymeric film. This generates a corresponding array of voids in the polymeric film, and gives rise to an “imaged stencil master” or stencil.

Stencils of this kind are routinely used in the electrochemical etching of metal parts. In this process, the stencil is placed on to the metal component to be etched and an electrolyte solution is applied to the stencil. Where voids exist, the electrolyte flows down to contact the component. An electric current is passed through the electrolyte into the component, resulting in the oxidation of the component surface where voids occur. The oxidised areas of the metal component appear darker than the surrounding metal to the naked eye, thus producing a visible image on the metal.

The use of conventional stencil masters to form stencils via this process poses a problem since the array of voids, which gives rise to the image, has very low optical contrast. As a consequence, it is difficult to position the stencil accurately prior to the etching process. It would therefore be desirable to provide a stencil having clearly visible voids, hence allowing accurate positioning of the stencil and consequent accurately positioned etched images.

### SUMMARY OF THE INVENTION

According to a first embodiment of the present invention, a heat-sensitive stencil master comprises a thermally-activatable colouring agent.

According to a second embodiment of the present invention, a stencil comprises a stencil master of the type described above which has been thermally imaged to produce voids and corresponding colour in said thermally-activatable colouring agent.

Further embodiments of the present invention include methods for manufacturing stencil masters, methods for manufacturing stencils, and the use of such stencils for example in electrochemical etching processes.

The present invention allows accurate position ing of the claimed stencil on to a substrate to be imaged, since the positions of the voids in the stencils are clearly visible.

### DETAILED DESCRIPTION OF THE INVENTION

Stencils and stencil masters of the present invention comprise a thermally-activatable colouring agent. In the context of this Application, a thermally-activatable colouring agent is any substance that undergoes a colour change on heating to a temperature above the ambient temperature before use (which may be, for instance, in the range 10° C. to 35° C. depending upon the environment) and up to the temperature of the thermal printing head used for imaging the stencil. Typical surface temperatures for thermal printing heads lie in the range 300° C. to 500° C. Preferably the colour change is irreversible.

The thermally-activatable colouring agent of the stencil master preferably comprises a chromogenic material and a colour developer. More preferably, said thermally-activatable colouring agent comprises a leuco dye system. Such systems typically contain basic colourless or lightly coloured chromogenic material and acidic colour developer.

Typically, the chromogenic material and the acidic colour developer are combined in such a way that reaction is inhibited before the application of heat. Thermally-activatable colouring agents of this kind are well known in the manufacture of direct thermal paper. The chemistry of leuco dyes and the formulation of heat-sensitive coatings based on these materials is described in patents such as U.S. Pat. No. 3,539,375, U.S. Pat. No. 3,674,535, U.S. Pat. No. 4,151,748, U.S. Pat. No. 4,181,771, U.S. Pat. No. 4,246,318, and U.S. Pat. No. 4,470,057.

Typically, the chromogenic material and the acidic colour developer are included in a continuous matrix, known in the art as a sensitiser, which melts under the application of heat to enable reaction of the two colour-forming components. The sensitiser is typically a waxy material, for example stearamide.

In another approach, the chromogenic material is encapsulated, along with the sensitiser, in another material, which is typically polymeric in nature. The capsules are then dispersed in the acidic colour developer. Under the action of heat the capsule wall melts enabling the chromogenic material and the acidic colour developer to come together in the sensitiser and undergo the colour forming reaction.

Typically the colour change produced by the thermally-activatable colouring agent is from white, often referred to as colourless, to black, however the thermally-activatable colouring agent can be one that changes from any colour to any other colour, provided that there is high enough contrast between the colours to produce a visible image.

Stencil masters of the present invention typically additionally comprise a heat-sensitive polymeric film and a porous layer. In what follows, the present invention is described primarily in relation to stencil masters of this type, although it should be understood that the invention is not so limited.

Preferably the thermally-activatable colouring agent is applied in the form of a coating, and more preferably this coating is on one of the surfaces of either the porous layer or the heat-sensitive impervious film.

This coating process may be carried out on the porous layer or the heat-sensitive impervious film before it is combined with the other stencil master components. However a preferred process is to apply the colour-forming coating to the surface of the porous layer opposite the heat-sensitive impervious film by coating a completed stencil master assembly.

Any suitable coating or printing method may be used to apply the thermally-activatable colouring agent to the porous layer. These include but are not restricted to, gravure coating, roller coating, mayer bar coating, spray coating, curtain coating, slot die coating, flexographic printing, screen printing and lithographic printing. Typically the coating is applied to the substrate as a continuous web, and typically the dried coating weight is from 5 to 20 g/m².

In an alternative embodiment, where the porous layer is formed from a resinous coating, the thermally-activatable colouring agent may be incorporated within this coating rather than being applied by a separate process.

Whichever technique is used to incorporate the thermally-activatable colouring agent into the stencil master, the thermally-activatable colouring agent may be dispersed in a carrier liquid. This carrier liquid may be water, a water solvent blend, or solvent only, and can be dried by known methods, including forced air and/or radiant energy. It is important that in the drying process the activation temperatures for the colour forming process and the initialisation of master film shrinkage are not exceeded. In addition, it is preferable that the thermally-activatable colouring agent is substantially evenly spread over the area to be imaged.

Stencil masters of the present invention typically additionally comprise a heat-sensitive polymeric film and a porous layer. The heat-sensitive polymeric film can be of the type used in conventional film-tissue laminate stencils. In particular, the heat-sensitive polymeric film must be capable of perforation by a thermal printing head of the type typically used in a digital duplicator printing machine. Preferably, it is less than 10 μm in thickness, typically less than 5 μm, for instance less than or equal to 3 μm in thickness.

The porous layer of the stencil master typically comprises either a solid resinous or polymeric foam, or tissue paper.

When tissue paper is used, it may be formed from natural fibres such as hemp, synthetic fibres, synthetic microfibres or blends thereof.

When a solid resinous foam is used the resin is typically thermoplastic or cross-linked. Suitable resins include but are not restricted to polymers, co-polymers or more complex polymeric permutations of ethylene, propylene, butene, butadiene, styrene, acrylonitrile, vinyl acetate, vinyl alcohol, vinyl acetal, vinyl butyral, vinyl formal, vinyl chloride, vinylidene chloride, vinyl fluoride, vinylidene fluoride, maleic anhydride, acrylic acid, methacrylic acid, acrylic acid esters, methacrylic acid esters, vinyl methyl ether or vinyl pyrrolidone. Also suitable are resins which fall within the categories of polyester, polyamide, polyurethane, cellulose ether, cellulose ester, nitrocellulose, polyketone, rubber, alkyd, polyphenylene oxide, polycarbonate, epoxy or silicone.

Porous solid resinous foams for use in this invention may be made by processes which have been previously described such as those of GB-A-2306689, GB-A-2336916 and GB-A-2350691. Alternatively, the porous solid resinous foam may be of the more recent type described in British patent application no. 0226910.8 (agent's ref: CJH02179 GB) the contents of which are incorporated herein by reference. Solid foams of this type are formed by coating a liquid foam on to the heat-sensitive film and drying the coating to form a porous resin layer. Typically the liquid foam comprises a liquid phase containing a volatile liquid and a resin. The resin is dissolved in the volatile liquid or incorporated as a resin emulsion or non-aqueous dispersion. In the context of the present application, a volatile liquid is one which will evaporate from the liquid foam while on the coating machine at a temperature of less than the shrink temperature of the heat-sensitive film. Typically, the volatile liquid will have a normal boiling point of at least 40° C. and at most 120° C., although liquids with higher boiling points may also prove useful provided that the drying conditions are selected so as to avoid substantial shrinkage of the heat-sensitive film. Non-aqueous liquids may be used, but the preferred liquid for use in the present invention is water, for processing and environmental reasons.

The solid foam coating that is formed is an open-cell solid foam which permits the flow of liquids, particularly ink, such that when the stencil master has been imaged to create voids in the heat-sensitive film, liquids entering the solid foam can exit via the voids in the film. Lateral connection of the cells in the solid foam is desirable to enable this component of the stencil to act as an ink reservoir and balance the supply of ink between areas where there is a large concentration of voids and areas where there are few or none. In order to achieve the desired degree of ink flow through the porous solid foam, and to avoid pores becoming blocked by pigmented ink, preferably most of the pores are greater than 5 μm in diameter, and more preferably greater than 10 μm in diameter.

In the case where the heat-sensitive stencil master does not comprise a polymeric film and porous layer, the thermally-activatable colouring agent may be coated on to or incorporated in to a stencil master substrate.

Stencils and stencil masters of the present invention may contain additional ingredients such as foaming agents, fibrous materials, pigments, fillers, antistatic agents, release agents, colourants, wetting agents, dispersing agents and viscosity modifiers.

Stencils of the present invention are formed by thermally imaging the stencil masters described above. This thermal imaging is typically carried out on a thermal imaging device such as a digital duplicator or a thermal label printer, or any other device that is capable of producing a pattern of heat corresponding to an image original that will produce that image on the stencil master.

In detail, when heat is applied to the stencil master, the heat-sensitive impervious film melts to produce a void, and the thermally-activatable colouring agent undergoes a colour change in the immediate vicinity of the heat source. Since this colour change occurs at molecular level, image resolution is limited only by the resolution capability of the thermal imaging device.

Stencils of the present invention find use as masks in electrochemical etching processes. However, their use as masks in other duplication techniques, such as printing and non-electrolytic etching, is also envisaged. Such duplication techniques can be used for security marking, in particular of aeroplane parts, although use for marking parts in a wide range of engineering applications is also envisaged.

The present invention is now illustrated by the following example.

### EXAMPLE

A commercially available colour change coating mix (Kromagen Black—supplied by Thermographic Measurements Companies) with an activation temperature of 70° C. was applied to the tissue side of a standard digital stencil material comprising a 2.0 μm thick thermally-sensitive polyester film with a thin silicone anti-stick coating on one surface and laminated to long fibre tissue 12 g/m², 44 μm thickness on the other surface. The coating mix was applied using a 0.08 mm diameter wire wound mayer bar. This process achieved an even coating where the coating mix was able to wick into the tissue and coat individual fibres without blocking the fibre interstices. The coating was dried with a warm air blower ensuring that the temperature of the stencil did not exceed 60° C. The weight of the coating was 8.15 g/m².

The coated stencil master was imaged using an IP48Win thermal label printer linked to a PC running MS Word. This process generated voids in the polymer film whilst at the same time causing a colourless to black colour change to occur in the tissue immediately adjacent to the voids. This colour was visible to the naked eye when viewed from the tissue side of the master material.

Using the visible image on the tissue the master material was manually positioned film side down, on to the metal component to be electrochemically etched. A sponge containing etching fluid (Universal Marking Systems MS—ME6 4169) was dabbed over the imaged area while an electric current was passed through the fluid. The current was provided by a Metaletch ME 2000T Etching Unit supplied by Universal Marking Systems. Where the fluid contacted the metal through the voids an image was generated on the metal part by the action of surface oxidisation.

1. A heat-sensitive stencil master comprising a thermally-activatable colouring agent.

2. A stencil master according to claim 1, further comprising
a heat-sensitive impervious polymeric film and
a porous layer.

3. A stencil master according to claim 2, wherein the porous layer comprises a solid resinous foam.

4. A stencil master according to claim 2, wherein the porous layer comprises tissue paper.

5. A stencil master according to claim 2, wherein the thermally-activatable colouring agent is incorporated within the porous layer.

6. A stencil master according to claim 1, wherein the thermally-activatable colouring agent undergoes an irreversible colour change on heating.

7. A stencil master according to claim 1, wherein the thermally-activatable colouring agent is applied as a coating.

8. A stencil master according to claim 7, wherein the thermally-activatable colouring agent is applied as a coating on the surface of the porous layer, opposite to the impervious polymeric film.

9. A stencil master according to claim 7, wherein the thermally-activatable colouring agent is applied as a coating on the surface of the porous layer, on the same side as the impervious polymeric film.

10. A stencil master according to claim 1, wherein the dry weight of the thermally-activatable colouring agent is from 5 to 20 g/m².

11. A stencil master according to claim 1, wherein the thermally-activatable colouring agent comprises a chromogenic material and a colour developer.

12. A stencil master according to claim 11 wherein the chromogenic material and the colour developer are included in the thermally-activatable colouring agent in such a way that a reaction between the chromogenic material and colour developer is inhibited before the application of heat.

13. A stencil master according to claim 11, further comprising a sensitizer which melts under the application of heat, said melting facilitating a reaction of the chromogenic material and colour developer.

14. A stencil master according to claim 13, wherein the sensitizer includes a wax.

15. A stencil master according to claim 1, wherein the thermally-activatable colouring agent comprises a leuco dye.

16. A method for manufacturing a heat-sensitive stencil master comprising coating a thermally-activatable colouring agent onto, or incorporating a thermally-activatable colouring agent into, a stencil master substrate.

17. The method according to claim 16, wherein the substrate comprises a heat-sensitive impervious polymeric film and a porous layer bonded to the film and said coating step comprises coating the thermally-activatable colouring agent onto the porous layer.

18. The method according to claim 16, wherein the substrate comprises a heat-sensitive impervious polymeric film and a porous layer and said coating step comprises coating the thermally-activatable colouring agent onto the porous layer and bonding the porous layer to the heat-sensitive impervious polymeric film.

19. The method according to claim 16, wherein said coating step comprises coating a liquid layer comprising a thermally-activatable colouring agent onto the surface of a heat-sensitive impervious film, and drying said liquid layer to form a solid porous layer, said stencil master substrate comprising the heat-sensitive impervious polymeric film and the porous layer.

20. A method for imaging a stencil master comprising a thermally-activatable colouring agent, said method comprising thermal imaging to produce one or more voids in at least one layer of the stencil master and a corresponding colour change in heated portions of said thermally-activatable colouring agent.

21. A stencil comprising a heat-sensitive stencil master including a thermally-activatable colouring agent, said stencil master being thermally imaged to produce one or more voids in said stencil master and corresponding colour changes in said thermally-activatable colouring agent.

22. A method for duplication, comprising forming one or more duplicates from a stencil comprising a stencil master substrate with one or more voids and a thermally-activatable colouring agent coating, said coating having a first colour and a colour different than the first colour corresponding to said voids.

23. A method of etching comprising
providing a stencil comprising a stencil master substrate with one or more voids and a thermally-activatable colouring agent coating, said coating having a first colour and a colour different than said first colour corresponding to said voids,
placing said stencil adjacent to an article to be etched, and
etching said article.

24. The method according to claim 23, wherein said etching step comprises applying an electrical current to the article.

25. The method according to claim 23 wherein said article is an airplane part.

26. A stencil comprising a stencil master substrate and a thermally-activatable colouring agent coating having a first colour, wherein said stencil master substrate contains one or more voids, and wherein portions of the thermally-activatable colouring agent coating corresponding to the voids in the stencil master substrate have a colour that is different than the first colour.
